(19) United States
(12) Patent Application Publication
(10) Pub. No.: US 2025/0181422 A1
(43) Pub. Date: Jun. 5, 2025

(54) CROSS-PHASE PARALLELIZATION AND OPTIMIZATION PLATFORM

(71) Applicant: SAP SE, Walldorf (DE)

(72) Inventors: Wulf Kruempelmann, Altlussheim (DE); Dominik Ofenloch, Lampertheim (DE)

(21) Appl. No.: 18/525,562

(22) Filed: Nov. 30, 2023

(51) Int. Cl. G06F 9/52

(52) U.S. Cl. CPC G06F 9/52

(57) ABSTRACT

Arrangements for cross-phase parallelization and optimization are provided. A worklist including metadata associated with executing a plurality of process phases may be stored in a database table. An initial phase of the plurality of process phases may be selected. Using the worklist, a long running task associated with a next phase may be identified, and the long running task may include a predecessor task. Based on determining that a process is available in the initial phase, the available process in the initial phase may be used to execute the predecessor task required for the next phase. A next task in the initial phase may be selected. After executing the predecessor task, the long running task may be executed in parallel with an execution of the next task using a remaining available process in the initial phase. The cross-phase parallelization procedure may be repeated for the next phase.

### TECHNICAL FIELD

The subject matter described herein relates generally to data processing and more specifically to a cross-phase parallelization and optimization platform.

### BACKGROUND

Mass data modification tools generally operate in different phases such as an analysis phase, a preparation phase, an execution phase, and post-processing phase. Typically, each phase runs in parallel processes to complete an operation as quickly as possible. However, only after the completion of all processes of a phase does the tool move on to the next phase. This leads to unnecessary delay and non-optimal runtimes.

### SUMMARY

Methods, systems, and articles of manufacture, including computer program products, are provided for cross-phase parallelization and optimization, for example, of mass data modification tools. In one aspect, there is provided a system including at least one processor and at least one memory. The at least one memory can store instructions that cause operations when executed by the at least one processor. The operations may include: generating, via a user device, a worklist, which may include metadata associated with executing a plurality of process phases, and the metadata may include a phase name, a task name, a task type, and a predecessor task; storing the worklist in a database table; selecting an initial phase of the plurality of process phases; identifying, using the worklist, a long running task associated with a next phase, and the long running task may include the predecessor task; based on determining that a process is available in the initial phase, using the available process in the initial phase to execute the predecessor task required for the next phase; selecting a next task in the initial phase; and after executing the predecessor task, executing, using a remaining available process in the initial phase, the long running task in parallel with an execution of the next task in the initial phase.

In some variations, one or more of the features disclosed herein including the following features can optionally be included in any feasible combination. In some variations, the predecessor task may begin or end before the next task proceeds.

In some variations, the plurality of process phases may include an analysis phase, a preparation phase, an execution phase, and a post activities phase.

In some variations, at least one of the plurality of process phases may be dependent on another phase.

In some variations, the task type may include the long running task or a repeatable task. In some variations, the long running task may include a task that runs for more than a predetermined duration of time.

In some variations, the operations may further include: receiving a returned process including a flag for re-execution; identifying a dependent process being returned; and based on determining that the dependent process has started, restarting the dependent process.

In some variations, the operations may further include: based on determining that no more processes are available in the initial phase, proceeding to processing in the next phase.

In some variations, the plurality of process phases may include database mass data modification processes.

In another aspect, there is provided a method for cross-phase parallelization and optimization, for example, of mass data modification tools. The method may include: generating, via a user device, a worklist, which may include metadata associated with executing a plurality of process phases, and the metadata may include a phase name, a task name, a task type, and a predecessor task; storing the worklist in a database table; selecting an initial phase of the plurality of process phases; identifying, using the worklist, a long running task associated with a next phase, and the long running task may include the predecessor task; based on determining that a process is available in the initial phase, using the available process in the initial phase to execute the predecessor task required for the next phase; selecting a next task in the initial phase; and after executing the predecessor task, executing, using a remaining available process in the initial phase, the long running task in parallel with an execution of the next task in the initial phase.

In some variations, one or more of the features disclosed herein including the following features can optionally be included in any feasible combination. In some variations, the predecessor task may begin or end before the next task proceeds.

In some variations, the plurality of process phases may include an analysis phase, a preparation phase, an execution phase, and a post activities phase.

In some variations, at least one of the plurality of process phases may be dependent on another phase.

In some variations, the task type may include the long running task or a repeatable task. In some variations, the long running task may include a task that runs for more than a predetermined duration of time.

In some variations, the operations may further include: receiving a returned process including a flag for re-execution; identifying a dependent process being returned; and based on determining that the dependent process has started, restarting the dependent process.

In some variations, the operations may further include: based on determining that no more processes are available in the initial phase, proceeding to processing in the next phase.

In some variations, the plurality of process phases may include database mass data modification processes.

In another aspect, there is provided a computer program product that includes a non-transitory computer readable medium. The non-transitory computer readable medium may store instructions that cause operations when executed by at least one data processor. The operations may include: generating, via a user device, a worklist, which may include metadata associated with executing a plurality of process phases, and the metadata may include a phase name, a task name, a task type, and a predecessor task; storing the worklist in a database table; selecting an initial phase of the plurality of process phases; identifying, using the worklist, a long running task associated with a next phase, and the long running task may include the predecessor task; based on determining that a process is available in the initial phase, using the available process in the initial phase to execute the predecessor task required for the next phase; selecting a next task in the initial phase; and after executing the predecessor task, executing, using a remaining available process in the initial phase, the long running task in parallel with an execution of the next task in the initial phase.

In some variations, one or more of the features disclosed herein including the following features can optionally be included in any feasible combination. In some variations, the predecessor task may begin or end before the next task proceeds.

Implementations of the current subject matter can include methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes, it should be readily understood that such features are not intended to be limiting. The claims that follow this disclosure are intended to define the scope of the protected subject matter.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts an illustrative computing environment for cross-phase parallelization and optimization in accordance with some example embodiments;

FIG. 2 depicts a flowchart illustrating a process for implementing cross-phase parallelization and optimization in accordance with some example embodiments;

FIG. 3 depicts an example database table operated upon by a cross-phase parallelization and optimization platform in accordance with some example embodiments; and

FIG. 4 depicts a block diagram illustrating a computing system, in accordance with some example embodiments.

When practical, similar reference numbers denote similar structures, features, or elements.

### DETAILED DESCRIPTION

Aspects of the disclosure may provide a cross-phase parallelization and optimization platform that optimizes performance of parallel processes while respecting order constraints. Further aspects of the disclosure optimizes runtime by enabling a smooth transition between process phases. For example, during an analysis phase, the cross-phase parallelization and optimization platform may start with a task of a preparation phase such that the computer load would be used more efficiently, removing gaps in the load. Similarly, as soon as there are no more work packages in an execution phase, the first processes of a subsequent post activities phase could start, resulting in a smooth transition and maintaining a high degree of parallelism between phases. Some tasks could proceed with their computation without waiting for other (e.g., slower) tasks, and thus the overall process becomes faster and more efficient. These and various other arrangements will be discussed more fully below.

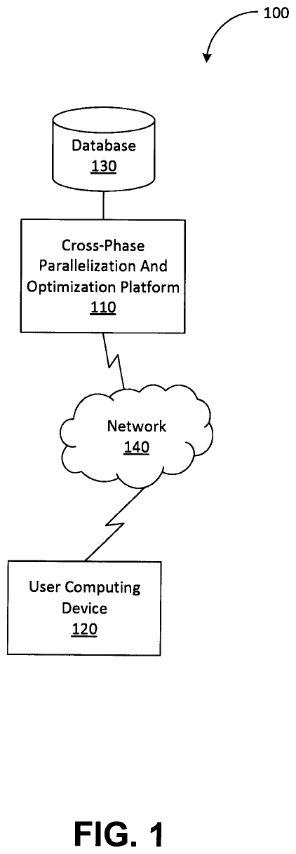

FIG. 1 depicts an illustrative computing environment 100 for cross-phase parallelization and optimization in accordance with some example embodiments. Referring to FIG. 1, the computing environment 100 may include one or more computing devices and/or other computing systems. For example, computing environment 100 may include a cross-phase parallelization and optimization platform 110, a user computing device 120, and a database 130. Cross-phase parallelization and optimization platform 110 may include one or more computing devices configured to perform one or more of the functions described herein. Cross-phase parallelization and optimization platform 110 may optimize runtime performance of a plurality of process phases by providing a smooth transition between process phases. For example, as soon as there are no more work packages in one phase, tasks of a subsequent phase could start. User computing device 120 may be a processor-based device including, for example, a smartphone, a tablet computer, a wearable apparatus, a virtual assistant, an Internet-of-Things (IoT) appliance, and/or the like. Database 130 may include, for example, a relational database, an in-memory database, a graph database, a key-value store, a document store, and/or the like. In some examples, the cross-phase parallelization and optimization platform 110 may maintain (e.g., store) various types of data, including metadata (e.g., meta information associated with executing a plurality of process phases) in one or more database tables at a database 130 coupled with the cross-phase parallelization and optimization platform 110.

Referring again to FIG. 1, the cross-phase parallelization and optimization platform 110, the user computing device 120, and the database 130 may be communicatively coupled via a network 140. The network 140 may be a wired and/or wireless network including, for example, a wide area network (WAN), local area network (LAN), a virtual local area network (VLAN), the Internet, and/or the like.

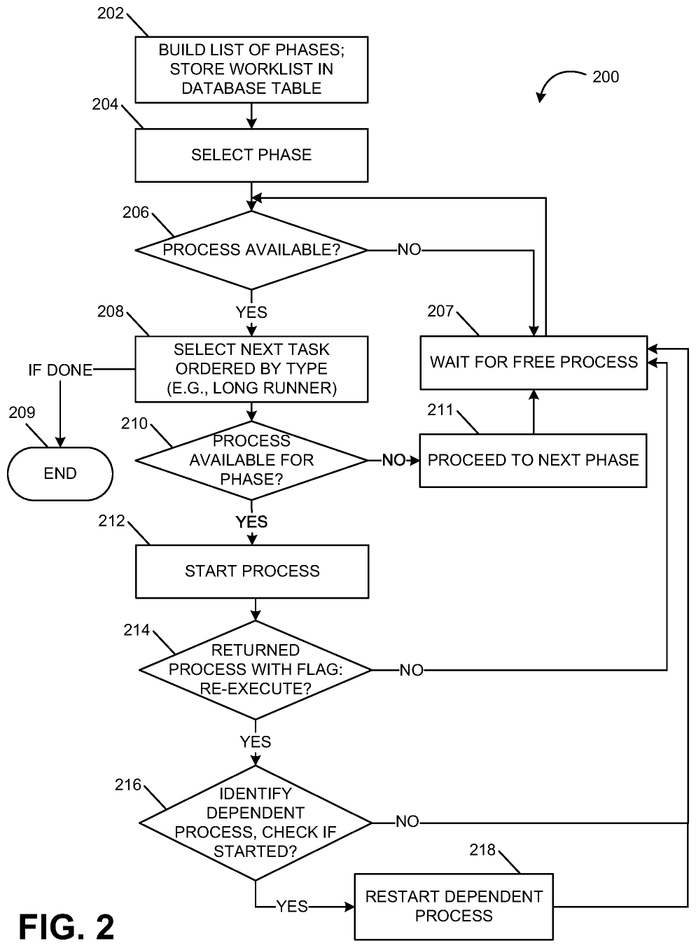

FIG. 2 depicts a flowchart 200 illustrating a process for implementing cross-phase parallelization and optimization, in accordance with some example embodiments. Referring to FIG. 2, at step 202, cross-phase parallelization and optimization platform 110 may generate or build, via a user device (e.g., user computing device 120), a worklist. The worklist may include metadata associated with executing a plurality of process phases. In some examples, the cross-phase parallelization and optimization platform 110 may store the worklist in a database table.

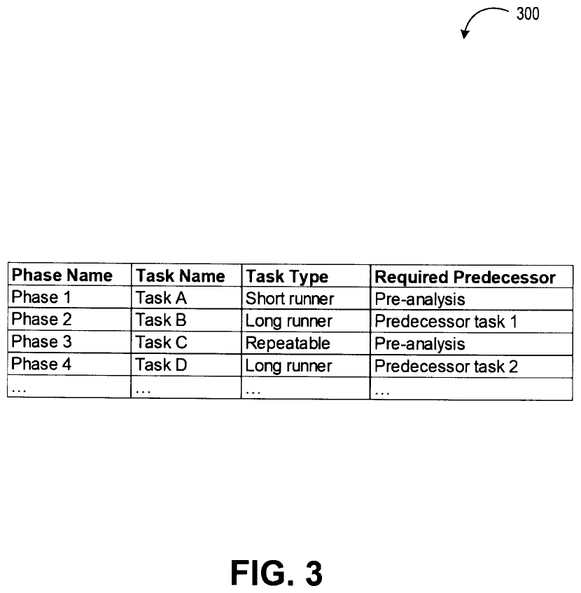

FIG. 3 depicts an example database table 300 operated upon by a cross-phase parallelization and optimization platform in accordance with some example embodiments. Referring to FIG. 3, metadata may include a phase name, a task name, a task type, and a predecessor task (e.g., required predecessors). In addition, the task type may include a long runner (e.g., a long running task that runs for more than a predetermined duration of time), a short runner (e.g., a short running task that runs for less than a predetermined duration of time), a repeatable task (e.g., a task that can be restarted/repeated if problems arise with the task), or a normal task (e.g., a mid-runner, belonging to none of long runner, short runner, or repeatable types). In some examples, tasks may be ordered by type (e.g., with long runners being processed first). It will be appreciated that other and/or different metadata may also be defined.

Returning to FIG. 2, at step 204, cross-phase parallelization and optimization platform 110 may select an initial phase of the plurality of process phases. The plurality of process phases may include, for example, an analysis phase (e.g., finetuning a set of data), a preparation phase (e.g., preparation of data, such as copying to shadow tables), an execution phase (e.g., execution of mass data modification), and a post activities phase (e.g., post processing and after modification operations such as generating special data, cleanup of data). Further, while four phases are used in this example, in other embodiments, less, more, or other phases may be contemplated. In some examples, at least one of the plurality of process phases is dependent on another phase. For instance, the results of an analysis phase might be based in part on of a subsequent preparation phase, and results of the preparation phase might be based in part on a subsequent post activities phase. Advantageously, cross-phase parallelization and optimization platform 110 resolves such dependencies to speed up processing and allow for a smooth transition between phases, as discussed further herein.

At step 206, cross-phase parallelization and optimization platform 110 may determine whether a process is available (e.g., whether there is a free process). If a process is not available (e.g., 206:NO), cross-phase parallelization and optimization platform 110 may, at step 207, wait for a free process to become available. If a process is available (e.g., 206:YES), cross-phase parallelization and optimization platform 110 may, at step 208, select a next task ordered by type (e.g., long runner or other). If no more tasks remain, the process ends at step 209. Otherwise, at step 208, cross-phase parallelization and optimization platform 110 may identify, using the worklist, a long running task associated with a next phase, which may include the predecessor task. Generally, the predecessor task must be completed or at least begin before another task can start (e.g., begins or ends before the next task proceeds).

At step 210, cross-phase parallelization and optimization platform 110 may determine whether a process is available in the initial phase. Based on determining that no more processes are available in the initial phase (e.g., 210:NO), cross-phase parallelization and optimization platform 110 may, at step 211, proceed to perform processing in the next phase. Based on determining that a process is available in the initial phase (e.g., 210:YES), cross-phase parallelization and optimization platform 110 may, at step 212, use the available process in the initial phase to execute the predecessor task required for the next phase. Then, cross-phase parallelization and optimization platform 110 may select a next task in the initial phase. After executing the predecessor task, cross-phase parallelization and optimization platform 110 may execute, using a remaining available process in the initial phase, the long running task in parallel with an execution of the next task in the initial phase.

In one non-limiting example, as a workload of one phase (e.g., an analysis phase) decreases, cross-phase parallelization and optimization platform 110 may proceed to a next phase (e.g., a preparation phase) and check, at the beginning of the phase, whether there are any long running tasks (e.g., long runners). Cross-phase parallelization and optimization platform 110 may start the long running task ahead of the next phase because it is time-consuming and takes a relatively long time (e.g., compared to short running tasks). By taking a task from the next phase and starting it just after the task from the first phase ended, a consumption time of the entire process may be shortened.

At step 214, based on the worklist, cross-phase parallelization and optimization platform 110 may receive a returned process including a flag for re-execution (e.g., 214:YES, which may indicate an error or failure of a process). In this case, cross-phase parallelization and optimization platform 110 may, at step 216, identify a dependent process being returned. Based on determining that the dependent process has started (e.g., 216:YES), cross-phase parallelization and optimization platform 110 may, at step 218, restart the dependent process and wait for a next free process (e.g., at step 207. On the other hand, if the dependent process has not started (e.g., 216:NO), cross-phase parallelization and optimization platform 110 may proceed directly to waiting for the next free process (e.g., at step 207).

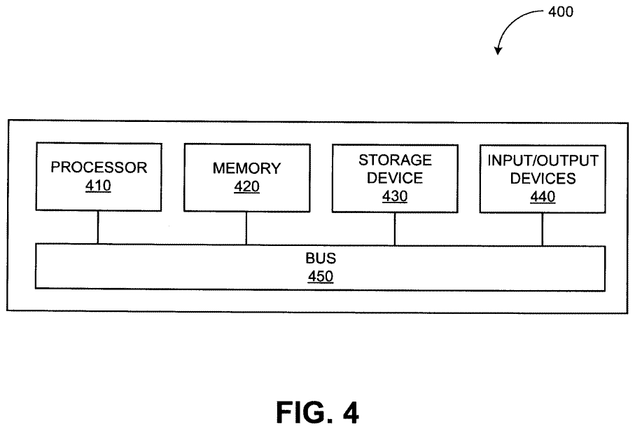

FIG. 4 depicts a block diagram illustrating a computing system 400 consistent with implementations of the current subject matter. Referring to FIGS. 1-4, the computing system 400 can be used to implement the cross-phase parallelization and optimization platform 110 and/or any components therein.

As shown in FIG. 4, the computing system 400 can include a processor 410, a memory 420, a storage device 430, and input/output devices 440. The processor 410, the memory 420, the storage device 430, and the input/output devices 440 can be interconnected via a system bus 450. The processor 410 is capable of processing instructions for execution within the computing system 400. Such executed instructions can implement one or more components of, for example, the cross-phase parallelization and optimization platform 110. In some implementations of the current subject matter, the processor 410 can be a single-threaded processor. Alternately, the processor 410 can be a multi-threaded processor. The processor 410 is capable of processing instructions stored in the memory 420 and/or on the storage device 430 to display graphical information for a user interface provided via the input/output device 440.

The memory 420 is a computer readable medium such as volatile or non-volatile that stores information within the computing system 400. The memory 420 can store data structures representing configuration object databases, for example. The storage device 430 is capable of providing persistent storage for the computing system 400. The storage device 430 can be a solid-state device, a floppy disk device, a hard disk device, an optical disk device, a tape device, and/or any other suitable persistent storage means. The input/output device 440 provides input/output operations for the computing system 400. In some implementations of the current subject matter, the input/output device 440 includes a keyboard and/or pointing device. In various implementations, the input/output device 440 includes a display unit for displaying graphical user interfaces.

According to some implementations of the current subject matter, the input/output device 440 can provide input/output operations for a network device. For example, the input/output device 440 can include Ethernet ports or other networking ports to communicate with one or more wired and/or wireless networks (e.g., a local area network (LAN), a wide area network (WAN), the Internet).

In some implementations of the current subject matter, the computing system 400 can be used to execute various interactive computer software applications that can be used for organization, analysis and/or storage of data in various (e.g., tabular) format (e.g., Microsoft Excel®, and/or any other type of software). Alternatively, the computing system 400 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities (e.g., SAP Integrated Business Planning add-in for Microsoft Excel as part of the SAP Business Suite, as provided by SAP SE, Walldorf, Germany) or can be standalone computing products and/or functionalities. Upon activation within the applications, the functionalities can be used to generate the user interface provided via the input/output device 440. The user interface can be generated and presented to a user by the computing system 400 (e.g., on a computer screen monitor, etc.).

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1: A system, comprising:
at least one data processor; and
at least one memory storing instructions, which when executed by the at least one data processor, result in operations comprising:
   generating, via a user device, a worklist, wherein the worklist comprises metadata associated with executing a plurality of process phases and the metadata comprises a phase name, a task name, a task type, and a predecessor task;
   storing the worklist in a database table;
   selecting an initial phase of the plurality of process phases;
   identifying, using the worklist, a long running task associated with a next phase, wherein the long running task comprises the predecessor task;
   based on determining that a process is available in the initial phase, using the available process in the initial phase to execute the predecessor task required for the next phase;
   selecting a next task in the initial phase; and
   after executing the predecessor task, executing, using a remaining available process in the initial phase, the long running task in parallel with an execution of the next task in the initial phase.

Example 2: The system of Example 1, wherein the predecessor task begins or ends before the next task proceeds.

Example 3: The system of any of Examples 1-2, wherein the plurality of process phases comprises an analysis phase, a preparation phase, an execution phase, and a post activities phase.

Example 4: The system of any of Examples 1-3, wherein at least one of the plurality of process phases is dependent on another phase.

Example 5: The system of any of Examples 1-4, wherein the task type comprises the long running task or a repeatable task.

Example 6: The system of any of Examples 1-5, wherein the long running task comprises a task that runs for more than a predetermined duration of time.

Example 7: The system of any of Examples 1-6, further comprising: receiving a returned process including a flag for re-execution; identifying a dependent process being returned; and based on determining that the dependent process has started, restarting the dependent process.

Example 8: The system of any of Examples 1-7, further comprising: based on determining that no more processes are available in the initial phase, proceeding to processing in the next phase.

Example 9: The system of any of Examples 1-8, wherein the plurality of process phases comprises database mass data modification processes.

Example 10: A computer-implemented method, comprising:
generating, via a user device, a worklist, wherein the worklist comprises metadata associated with executing a plurality of process phases and the metadata comprises a phase name, a task name, a task type, and a predecessor task;
storing the worklist in a database table;
selecting an initial phase of the plurality of process phases;
identifying, using the worklist, a long running task associated with a next phase, wherein the long running task comprises the predecessor task;
based on determining that a process is available in the initial phase, using the available process in the initial phase to execute the predecessor task required for the next phase;
selecting a next task in the initial phase; and
after executing the predecessor task, executing, using a remaining available process in the initial phase, the long running task in parallel with an execution of the next task in the initial phase.

Example 11: The computer-implemented method of Example 10, wherein the predecessor task begins or ends before the next task proceeds.

Example 12: The computer-implemented method of any of Examples 10-11, wherein the plurality of process phases comprises an analysis phase, a preparation phase, an execution phase, and a post activities phase.

Example 13: The computer-implemented method of any of Examples 10-12, wherein at least one of the plurality of process phases is dependent on another phase.

Example 14: The computer-implemented method of any of Examples 10-13, wherein the task type comprises the long running task or a repeatable task.

Example 15: The computer-implemented method of any of Examples 10-14, wherein the long running task comprises a task that runs for more than a predetermined duration of time.

Example 16: The computer-implemented method of any of Examples 10-15, further comprising: receiving a returned process including a flag for re-execution; identifying a dependent process being returned; and based on determining that the dependent process has started, restarting the dependent process.

Example 17: The computer-implemented method of any of Examples 10-16, further comprising: based on determining that no more processes are available in the initial phase, proceeding to processing in the next phase.

Example 18: The computer-implemented method of any of Examples 10-17, wherein the plurality of process phases comprises database mass data modification processes.

Example 19: A non-transitory computer readable medium storing instructions, which when executed by at least one data processor, result in operations comprising:
generating, via a user device, a worklist, wherein the worklist comprises metadata associated with executing a plurality of process phases and the metadata comprises a phase name, a task name, a task type, and a predecessor task;
storing the worklist in a database table;
selecting an initial phase of the plurality of process phases;
identifying, using the worklist, a long running task associated with a next phase, wherein the long running task comprises the predecessor task;
based on determining that a process is available in the initial phase, using the available process in the initial phase to execute the predecessor task required for the next phase;
selecting a next task in the initial phase; and
after executing the predecessor task, executing, using a remaining available process in the initial phase, the long running task in parallel with an execution of the next task in the initial phase.

Example 20: The non-transitory computer readable medium of Example 19, wherein the predecessor task begins or ends before the next task proceeds.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. For example, the logic flows may include different and/or additional operations than shown without departing from the scope of the present disclosure. One or more operations of the logic flows may be repeated and/or omitted without departing from the scope of the present disclosure. Other implementations may be within the scope of the following claims.

What is claimed is:

1. A system, comprising:
at least one data processor; and
at least one memory storing instructions, which when executed by the at least one data processor, result in operations comprising:
generating, via a user device, a worklist, wherein the worklist comprises metadata associated with executing a plurality of process phases and the metadata comprises a phase name, a task name, a task type, and a predecessor task;
storing the worklist in a database table;
selecting an initial phase of the plurality of process phases;
identifying, using the worklist, a long running task associated with a next phase, wherein the long running task comprises the predecessor task;
based on determining that a process is available in the initial phase, using the available process in the initial phase to execute the predecessor task required for the next phase;
selecting a next task in the initial phase; and
after executing the predecessor task, executing, using a remaining available process in the initial phase, the long running task in parallel with an execution of the next task in the initial phase.

2. The system of claim 1, wherein the predecessor task begins or ends before the next task proceeds.

3. The system of claim 1, wherein the plurality of process phases comprises an analysis phase, a preparation phase, an execution phase, and a post activities phase.

4. The system of claim 1, wherein at least one of the plurality of process phases is dependent on another phase.

5. The system of claim 1, wherein the task type comprises the long running task or a repeatable task.

6. The system of claim 1, wherein the long running task comprises a task that runs for more than a predetermined duration of time.

7. The system of claim 1, further comprising:
receiving a returned process including a flag for re-execution;
identifying a dependent process being returned; and
based on determining that the dependent process has started, restarting the dependent process.

8. The system of claim 1, further comprising:
based on determining that no more processes are available in the initial phase, proceeding to processing in the next phase.

9. The system of claim 1, wherein the plurality of process phases comprises database mass data modification processes.

10. A computer-implemented method, comprising:
generating, via a user device, a worklist, wherein the worklist comprises metadata associated with executing a plurality of process phases and the metadata comprises a phase name, a task name, a task type, and a predecessor task;
storing the worklist in a database table;
selecting an initial phase of the plurality of process phases;
identifying, using the worklist, a long running task associated with a next phase, wherein the long running task comprises the predecessor task;
based on determining that a process is available in the initial phase, using the available process in the initial phase to execute the predecessor task required for the next phase;
selecting a next task in the initial phase; and
after executing the predecessor task, executing, using a remaining available process in the initial phase, the long running task in parallel with an execution of the next task in the initial phase.

11. The computer-implemented method of claim 10, wherein the predecessor task begins or ends before the next task proceeds.

12. The computer-implemented method of claim 10, wherein the plurality of process phases comprises an analysis phase, a preparation phase, an execution phase, and a post activities phase.

13. The computer-implemented method of claim 10, wherein at least one of the plurality of process phases is dependent on another phase.

14. The computer-implemented method of claim 10, wherein the task type comprises the long running task or a repeatable task.

15. The computer-implemented method of claim 10, wherein the long running task comprises a task that runs for more than a predetermined duration of time.

16. The computer-implemented method of claim 10, further comprising:
receiving a returned process including a flag for re-execution;
identifying a dependent process being returned; and
based on determining that the dependent process has started, restarting the dependent process.

17. The computer-implemented method of claim 10, further comprising:
based on determining that no more processes are available in the initial phase, proceeding to processing in the next phase.

18. The computer-implemented method of claim 10, wherein the plurality of process phases comprises database mass data modification processes.

19. A non-transitory computer readable medium storing instructions, which when executed by at least one data processor, result in operations comprising:
generating, via a user device, a worklist, wherein the worklist comprises metadata associated with executing a plurality of process phases and the metadata comprises a phase name, a task name, a task type, and a predecessor task;
storing the worklist in a database table;
selecting an initial phase of the plurality of process phases;
identifying, using the worklist, a long running task associated with a next phase, wherein the long running task comprises the predecessor task;
based on determining that a process is available in the initial phase, using the available process in the initial phase to execute the predecessor task required for the next phase;
selecting a next task in the initial phase; and
after executing the predecessor task, executing, using a remaining available process in the initial phase, the long running task in parallel with an execution of the next task in the initial phase.

20. The non-transitory computer readable medium of claim 19, wherein the predecessor task begins or ends before the next task proceeds.
